(19) United States
(12) Patent Application Publication
(10) Pub. No.: US 2025/0356597 A1
(43) Pub. Date: Nov. 20, 2025

(54) SYSTEMS AND METHODS FOR TRANSFERRING AUTOMATIC CONTROL OF A VEHICLE USING VIRTUAL MARKINGS

(71) Applicant: Toyota Jidosha Kabushiki Kaisha, Toyota-shi Aichi-ken (JP)

(72) Inventors: Michael L. Elkins, Framingham, MA (US); Jaime S. Camhi-Espinoza, Los Gatos, CA (US)

(21) Appl. No.: 18/663,712

(22) Filed: May 14, 2024

(51) Int. Cl. G06T 19/00; B60W 60/00; G02B 27/01

(52) U.S. Cl. CPC G06T 19/006; B60W 60/001; G02B 27/0101

(57) ABSTRACT

System, methods, and other embodiments described herein relate to transferring automatic control of a vehicle through emulating virtual markings and estimating a buffer zone. In one embodiment, a method includes estimating a position for a takeover by a vehicle that is directly controlling driving maneuvers. The method also includes predicting an automated region from a transition time and the position for the takeover by an operator. The method also includes generating virtual markings for the takeover using the automated region and the position, wherein the virtual markings exist within the automated region and the position indicates an area for manual feedback to the vehicle.

### TECHNICAL FIELD

The subject matter described herein relates, in general, to transferring automatic control to an operator, and, more particularly, to transferring automatic control of a vehicle using virtual markings and a buffer zone.

### BACKGROUND

Systems coordinate a takeover of an automated vehicle that involves transferring vehicle control from an automated system to an operator. In one approach, a system uses sensor data from cameras, light detection and ranging (LiDAR), radar, ultrasonic sensors, etc., to perceive vehicle surroundings. For example, a vehicle may be equipped with a light detection and ranging (LIDAR) sensor that uses light to scan the surrounding environment, while logic associated with the LIDAR analyzes acquired data to detect a presence of objects and other features of the surrounding environment. In further examples, additional/alternative sensors such as cameras may be implemented to acquire information about the surrounding environment from which a system derives awareness about aspects of the surrounding environment. Perception can involve monitoring the environment for potential hazards, obstacles, and situations that the automated system can find difficult to navigate safely. The system can also assess a risk level of a potential hazard and determine whether transferring control to the operator is safe depending on data quality. The system notifies an operator when intervention can mitigate collision risk through alerts. Still, systems assessing risk levels and generating alerts can impact safety when data is inaccurate and alerts are untimely.

In various implementations, systems plan takeovers rather than monitoring environments for situational risks using the sensor data. For example, an automated system for a vehicle has capabilities for situations within highway environments. As such, the automated system coordinates with other systems to schedule a takeover to the operator when outside of highway environments. However, system coordinating takeovers that are planned encounter difficulties preparing an operator and computing thresholds from data availability for gracefully switching control. Therefore, systems managing takeovers for automated vehicles face challenges with safety and timeliness from situational and planning analysis.

### SUMMARY

In one embodiment, example systems and methods relate to transferring automatic control of a vehicle using virtual markings and a buffer zone that are estimated. In various implementations, automated vehicles have operating thresholds that are set by manufacturers. An operating threshold can be situational such that a scenario is overly complex for vehicle capabilities and equipment. Other thresholds are conditional such as operating during poor visibility, inclement weather, etc. Systems account for the operating thresholds when assessing the necessity for changing controls of an automated vehicle, such as a takeover from an automated level. Here, a takeover may be when an automated vehicle transfers vehicle control (e.g., steering, braking, accelerating, etc.) from an automated system to an operator. Systems predicting and coordinating takeovers face complications from transferring controls associated with a takeover, such as operators being insufficiently attentive of driving environments and ignoring transition alerts (e.g., audible alarms).

Therefore, in one embodiment, an estimation system predicts an endpoint for automated driving and assists an operator using virtual marking with a takeover to a state involving manual commands. Here, an automated region may exist geographically between a current position and the endpoint. When a vehicle will transition to the state beyond the endpoint known through predictions (e.g., leaving a mapped zone), the estimation system informs the operator with virtual markings and feedback of a takeover before a transition time. In particular, the transition time can act as a buffer zone for the transition where manual control from the operator is expected. For example, a heads-up display outputs the virtual markings as a caution zone within the automated region. Furthermore, the estimation system emulates physical effects (e.g., audible alarms, vibrating components) associated with the virtual markings at points within the caution zone. In one approach, the estimation system automatically stops the vehicle upon the takeover and manual control of the vehicle by the operator during the transition time being insufficient. Accordingly, the estimation system prepares an operator for a takeover by predicting the endpoint and virtually emulating road markings, thereby improving comfort and safety associated with automated driving.

In one embodiment, an estimation system that transfers automatic control of a vehicle through emulating virtual markings and estimating a buffer zone is disclosed. The estimation system includes a memory storing instructions that, when executed by a processor, cause the processor to estimate a position for a takeover by a vehicle that is directly controlling driving maneuvers. The instructions also include instructions to predict an automated region from a transition time and the position for the takeover by an operator. The instructions also include instructions to generate virtual markings for the takeover using the automated region and the position, wherein the virtual markings exist within the automated region and the position indicates an area for manual feedback to the vehicle.

In one embodiment, a non-transitory computer-readable medium for transferring automatic control of a vehicle through emulating virtual markings and estimating a buffer zone and including instructions that when executed by a processor cause the processor to perform one or more functions is disclosed. The instructions include instructions to estimate a position for a takeover by a vehicle that is directly controlling driving maneuvers. The instructions also include instructions to predict an automated region from a transition time and the position for the takeover by an operator. The instructions include instructions to generate virtual markings for the takeover using the automated region and the position, wherein the virtual markings exist within the automated region and the position indicates an area for manual feedback to the vehicle.

In one embodiment, a method for transferring automatic control of a vehicle through emulating virtual markings and estimating a buffer zone is disclosed. In one embodiment, the method includes estimating a position for a takeover by a vehicle that is directly controlling driving maneuvers. The method also includes predicting an automated region from a transition time and the position for the takeover by an operator. The method also includes generating virtual markings for the takeover using the automated region and the position, wherein the virtual markings exist within the automated region and the position indicates an area for manual feedback to the vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an estimation system that is associated with transferring automatic control of a vehicle using virtual markings and a buffer zone that are estimated.

FIGS. 3A and 3B illustrate one embodiment of the estimation system of FIG. 2 generating virtual markings for a takeover and a view involving an automated region and a position.

FIG. 4 illustrates one embodiment of a method that is associated with predicting an automated region for a vehicle from a transition time and a position for an operator takeover.

### DETAILED DESCRIPTION

Systems, methods, and other embodiments associated with transferring automatic control of a vehicle through emulating virtual markings and estimating a buffer zone are disclosed herein. In various implementations, vehicles have geographic limits for primarily and automatically controlling driving maneuvers without manual oversight. For example, a vehicle self-drives on freeways and regions having a high-definition (HD) map and otherwise handovers control to an operator through a takeover procedure. Here, the vehicle can display a driving status, perceived surroundings, and notify the operator about changes associated with automatic driving. As such, the operator can develop situational awareness from the driving status that informs the operator about safety behavior, upcoming hazards, and reasons for the takeover from automatic driving. However, vehicles alerting the operator about the situational awareness can be jarring and unpleasant, especially when danger is imminent. Furthermore, systems using subtle alerts can be insufficient at informing operators about driving conditions. Thus, systems assisting operators with situational awareness about automatic driving for a takeover can startle and face delays, thereby reducing safety.

Therefore, in one embodiment, an estimation system generates an interface and alerts through virtual markings for developing situational awareness and informing an operator about a takeover from automatic driving gracefully. Here, the estimation system can predict an automated region from a transition time and a position for the takeover. The automated region can be an area remaining where the vehicle primarily controls maneuvers with manual feedback that is minimal (e.g., full automation) according to changing conditions, automation levels, geography, etc. For example, the automated region is an area changing from a high-speed area to a local area. The estimation system can calculate the position for determining the automated region from map data (e.g., road edges, road boundaries, etc.), vehicle speed, and perceptions estimated about a surrounding area from sensor data. The transition time can be a buffer zone that is scheduled where the vehicle 100 demands manual feedback since capabilities become inadequate for automatic driving. As such, the vehicle can share control with the operator during the transition time such that the operator inputs primary commands and the vehicle assists with secondary commands.

Moreover, in one embodiment, the estimation system generates virtual markings for a takeover using the automated region and the position. For example, the vehicle displays the virtual markings on a heads-up display (HUD) through overlaying images that augment a scene surrounding the vehicle. Here, the virtual markings can emulate a caution zone on a road using alert points. For instance, the estimation system vibrates a vehicle element (e.g., a steering wheel, a seat, etc.) corresponding with the alert points within the caution zone that mimic rumble strips for indicating the automated region ending and the upcoming takeover. In another approach, the vehicle automatically stops upon insufficient takeover and manual control by the operator during the transition time. In this way, the estimation system develops situational awareness for the operator while preventing an unsafe scenario where automated driving is incapable after the buffer zone. Accordingly, the estimation system assists the operator with developing an understanding of an operational domain associated with capabilities for the vehicle, thereby improving confidence and safety with automatic driving.

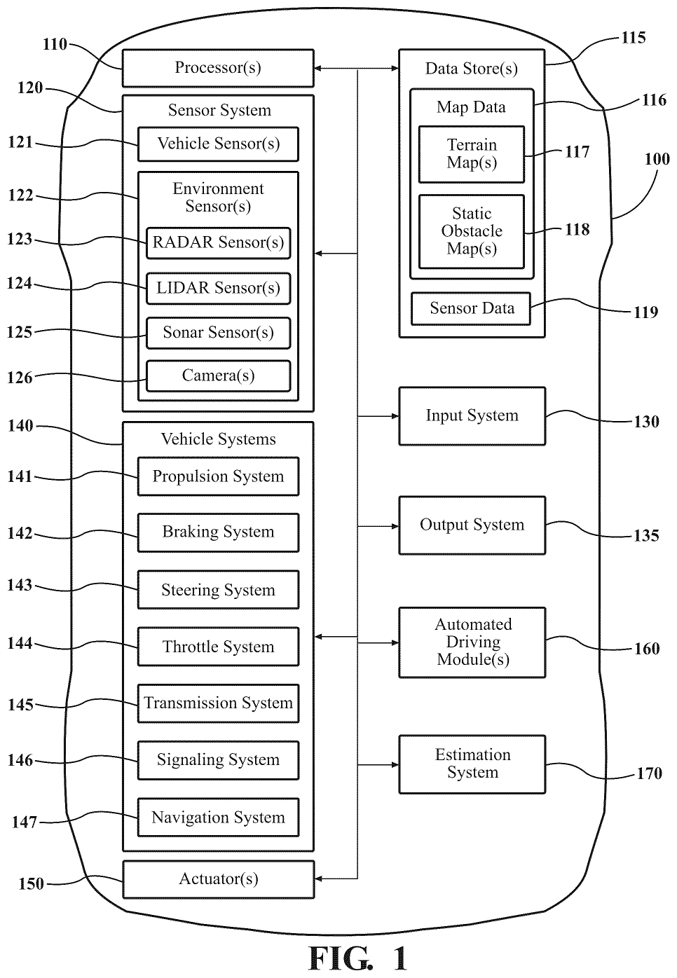

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an estimation system 170 uses road-side units (RSU), consumer electronics (CE), mobile devices, robots, drones, and so on that benefit from the functionality discussed herein associated with transferring automatic control of a vehicle using virtual markings and a buffer zone that are estimated.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

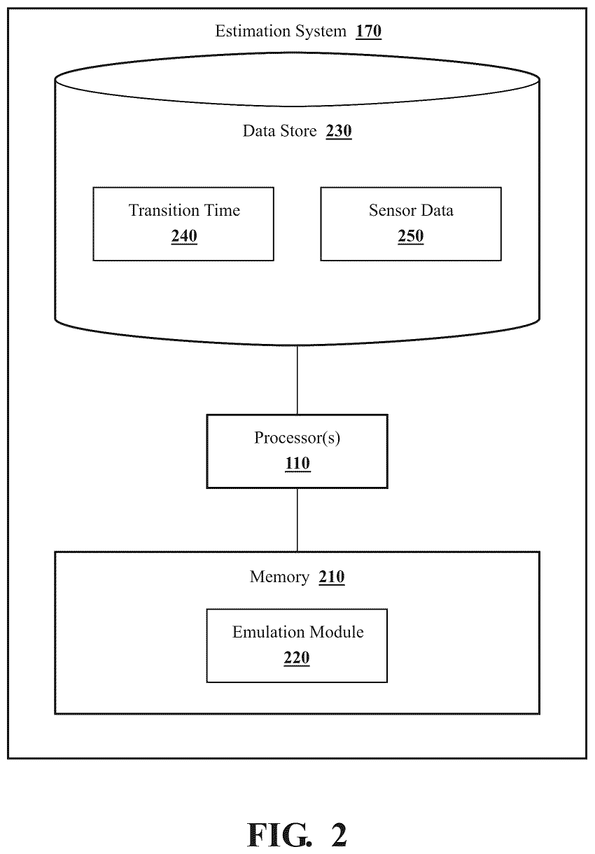

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an estimation system 170 that is implemented to perform methods and other functions as disclosed herein relating to transferring automatic control of a vehicle using virtual markings and a buffer zone that are estimated.

With reference to FIG. 2, one embodiment of the estimation system 170 of FIG. 1 is further illustrated. The estimation system 170 is shown as including a processor(s) 110 from the vehicle 100 of FIG. 1. Accordingly, the processor(s) 110 may be a part of the estimation system 170, the estimation system 170 may include a separate processor from the processor(s) 110 of the vehicle 100, or the estimation system 170 may access the processor(s) 110 through a data bus or another communication path. In one embodiment, the estimation system 170 includes a memory 210 that stores an emulation module 220. The memory 210 is a random-access memory (RAM), a read-only memory (ROM), a hard-disk drive, a flash memory, or other suitable memory for storing the emulation module 220. The emulation module 220 is, for example, computer-readable instructions that when executed by the processor(s) 110 cause the processor(s) 110 to perform the various functions disclosed herein.

The estimation system 170 as illustrated in FIG. 2 is generally an abstracted form of the estimation system 170 as may be implemented between the vehicle 100 and a cloud-computing environment. Furthermore, the estimation system 170 and the emulation module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the estimation system 170, in one embodiment, acquires sensor data 250 that includes at least camera images. In further arrangements, the estimation system 170 acquires the sensor data 250 from further sensors such as radar sensors 123, LIDAR sensors 124, and other sensors as may be suitable for identifying vehicles and locations of the vehicles.

Accordingly, the estimation system 170, in one embodiment, controls the respective sensors to provide the data inputs in the form of the sensor data 250. Additionally, while the estimation system 170 is discussed as controlling the various sensors to provide the sensor data 250, in one or more embodiments, the estimation system 170 can employ other techniques to acquire the sensor data 250 that are either active or passive. For example, the estimation system 170 may passively sniff the sensor data 250 from a stream of electronic information provided by the various sensors to further components within the vehicle 100. Moreover, the estimation system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 may also include, for example, information about lane markings, and so on. Of course, in alternative embodiments, the estimation system 170 may acquire the sensor data about a forward direction alone when, for example, the vehicle 100 is not equipped with further sensors to include additional regions about the vehicle and/or the additional regions are not scanned due to other reasons.

Moreover, in one embodiment, the estimation system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the emulation module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on.

In another embodiment, the data store 230 further includes the transition time 240 representing a buffer zone where the vehicle 100 expects an operator to primarily control driving maneuvers after a takeover. The transition time 240 can factor attentiveness of the operator derived from the sensor data 250, a stopping distance of the vehicle 100, and an automation level associated with the driving maneuvers. For example, the transition time 240 is greater than the stopping distance and a buffer time. In this way, the estimation system 170 and the vehicle 100 can trigger safety actions upon the operator taking insufficient action during the transition time 240.

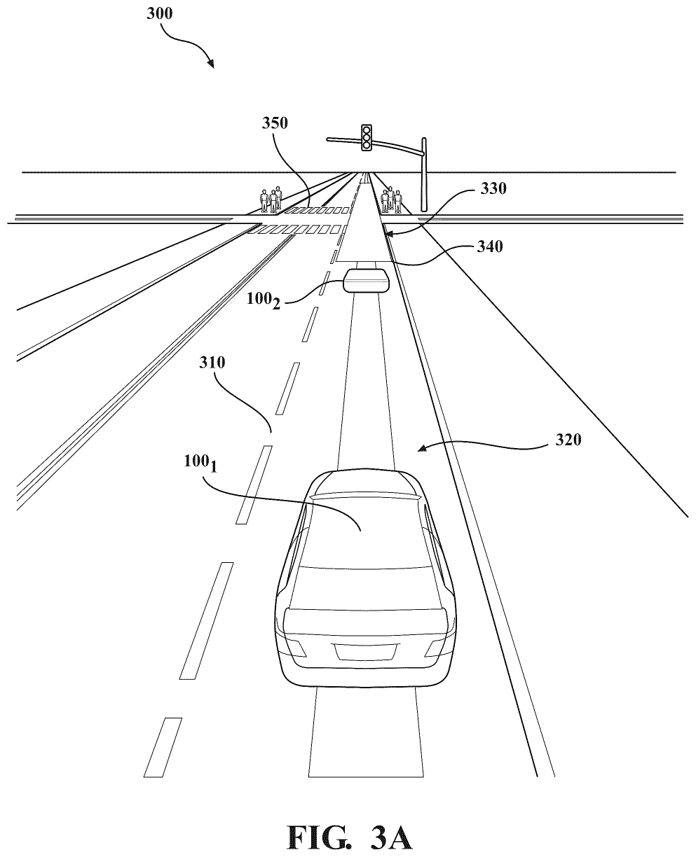

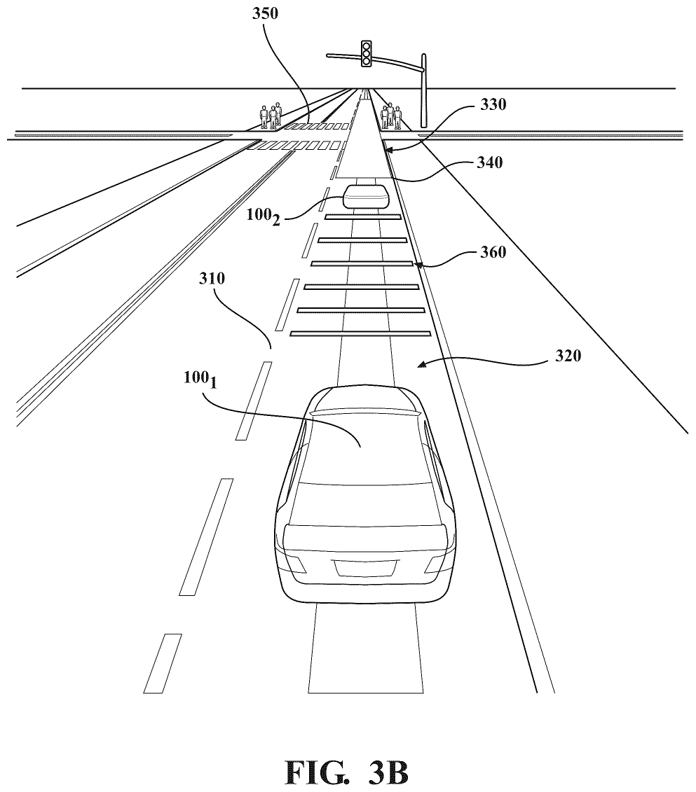

Now turning to FIGS. 3A and 3B, embodiments of the estimation system 170 of FIG. 2 generating virtual markings for a takeover and a view involving an automated region and a position are illustrated. FIG. 3A improves challenges with alerting operators about takeovers through increasing situational awareness and knowledge about operational domains for the vehicle 100. Here, the takeover can be triggered from conditional changes (e.g., weather), scheduled, etc., on the road 310. Rather than suddenly presenting the operator of the vehicle 100 about a transition triggered by an imminent event through escalating an alarm, the estimation system 170 generates an environment and feedback 300, making the takeover increasingly natural. As further explained below, the environment and feedback 300 reduces operator stress by gracefully assisting with the takeover with an automated region 320 and a transition time 330 using visual and tactile feedback, thereby improving system experience and comfort. Regarding the automated region 320, the region can be an area remaining where the vehicle primarily controls maneuvers with manual feedback that is limited (e.g., full automation) according to changing conditions, automation levels, geography, etc. For example, the automated region is an area where a highway ends at an upcoming intersection 350.

In FIG. 3A, the estimation system 170, in one embodiment, is further configured to perform additional tasks beyond controlling the respective sensors to acquire and provide the sensor data 250. For example, the estimation system 170 includes instructions that cause the processor 110 to estimate a position 340 for a takeover by the vehicle 100 that is directly controlling driving maneuvers within the road 310. Here, the position 340 can represent a planned location and geographic boundary for the takeover using map data (e.g., road edges, road boundaries, etc.) as geography changes from a high-speed area to a local area. Furthermore, the operator and the estimation system 170 can negotiate the planned location for transferring from automatic control such as through route planning. For instance, scheduling the takeover involves comparing the position 340 with map data indicating that the vehicle 100 is incapable of autonomously controlling the driving maneuvers beyond the automated region 320 and the operator can manage the takeover.

Moreover, a geographic boundary may exist during automatic driving since an automation level is incapable of primarily controlling the vehicle 100, such as at reduced speeds. The automation level may be one of levels 0-5 defined by the Society of Automotive Engineers (SAE). The automation level can categorize the extent that the vehicle 100 can operate with limited or without human input. Level 0 lacks automation such that an operator controls the vehicle 100. Level 1 is driver assistance such as cruise control and lane-keeping where the vehicle 100 assists the operator with driving commands that are limited. Level 2 involves partial automation where the vehicle 100 controls steering and speed under certain conditions while demanding operator attention (e.g., Autopilot by Tesla). Level 3 is conditional automation such that the vehicle 100 can handle primary driving tasks in specific conditions while demanding that the operator is ready for a takeover when prompted. Level 4 is high automation where the vehicle 100 can operate automatically in predefined conditions or areas while demanding operator intervention among limited scenarios. Level 5 involves full automation such that the vehicle 100 operates driving tasks under most conditions without operator intervention (e.g., steering, pedaling, etc.).

Along with automation levels, in one approach, the estimation system 170 triggers a takeover at the position 340 due to driving conditions that conflict with an automation level. For example, the vehicle 100 is unable to operate under level 5 when another vehicle 1002 as displayed virtually maneuvers aggressively. Similarly, the vehicle 100 is unable to operate under level 4 when the road 310 is icy. Thus, the estimation system 170 can estimate the position for scheduled and unscheduled takeovers of the vehicle 100 using map data, automation levels, driving conditions, etc.

Moreover, in one embodiment, the estimation system 170 can predict the automated region 320 from a transition time 330 and the position 340 for the takeover by an operator. For instance, the estimation system 170 calculates the position for determining the automated region 320 from map data, vehicle speed towards the position 340, and perceptions estimated about a surrounding area from the sensor data 250. The transition time can be a buffer zone that is scheduled where the vehicle 100 demands manual feedback since capabilities become inadequate for autonomous driving. In one approach, the transition time 330 is predetermined according to an automation level and capabilities of the automation level for autonomously controlling the vehicle 100 within an area. For example, the transition time 330 is a buffer zone needed for the vehicle 100 transferring control to the operator from level 5 to level 1 when approaching the intersection 350. The transfer and a takeover may be demanded since the level 5 specifications for vehicle 100 is incapable of safely navigating the intersection 350 and the operator should primarily control the vehicle 100 for safety.

In various implementations, the emulation module 220 generates virtual markings for the takeover using the automated region 320 and the position 340. For instance, the virtual markings exist within the automated region 320 and the position 340 indicates an area beginning for manual feedback of the vehicle 100. Here, the vehicle 100 can display the virtual markings, a virtual twin 1001 of the vehicle 100, and a vehicle 1002 ahead on the road 310 using an output system 135. Displaying the virtual markings can assist the operator with understanding operating domains and capabilities for an automation level as well as situational awareness. Thus, the virtual markings can reduce stress and increase comfort when the vehicle 100 transitions for automatic control during the automated region 320 and the transition time 330 (e.g., several seconds) where operator control resumes.

In FIG. 3B, in one approach, the emulation module 220 and the output system 135 display virtual markings 360 on the road 310 beyond the virtual twin 1001 for clearly indicating an upcoming transition time 330. Here, the position 340 can be a domain edge where automatic control of the vehicle 100 ends due to changing geography, driving conditions, perception predictions, position predictions, etc., that demand manual inputs. The virtual markings 360 can be feedback generated on a HUD through overlaying images that augment a scene surrounding the vehicle 100. For example, the virtual markings 360 emulate a caution zone, painted lines, slow zones, etc., on the road 310 within the scene. As such, the virtual markings 360 could warn an end of automatic control such as due to upcoming toll booths, school drop-offs, etc. In another approach, the emulation module 220 color-codes the virtual markings 360 and the automated region 320, such as according to the automation level, automation status, etc. This can include using a defined color (e.g., yellow, white, etc.) indicating a proximity to the transition time 330 and the position 340. In this way, the operator becomes familiar with transferring between automatic control and an area demanding manual inputs.

The automated region 320 having the virtual markings 360 and the transition time 330 may define a disengagement zone for the vehicle 100. The automated region 320 can be associated with a distance and time (e.g., several seconds) until a takeover at the position 340. In one approach, the virtual markings 360 is accompanied with audible, haptic, etc., warnings about the takeover before the transition time 330. Here, one or more actuators 150 can vibrate a vehicle element corresponding with points within a caution zone. The one or more actuators 150 may be one of an electromagnetic suspension that is purpose built and a haptic motor. The vehicle element may be one of a seat base, a holster, a chassis, and a steering wheel. For instance, a haptic motor increasingly vibrates the steering wheel along points of the virtual markings 360 as the vehicle 100 approaches the position 340 and the transition time 330. The vibrations can also mimic rumble strips that trigger as the vehicle 100 passes points along the virtual markings 360. Similarly, the vehicle 100 controls the electromagnetic suspension to move, vibrate, gyrate, etc., the chassis in a manner replicating the feel of rumble strips along the virtual markings 360 and the road 310. Furthermore, the automated region 320 and the transition time 330 can differ visually within the disengagement zone. In one approach, the emulation module 220 displays the transition time 330 with a bolder color (e.g., red) than the automated region 320. In this way, the operator cognitively understands and builds awareness about the different areas and stages for the takeover, thereby improving driving comfort and safety.

Upon reaching the transition time 330, the estimation system 170 further assists the operator with transferring from automatic control of the vehicle 100. Here, the transition time 330 can begin at the position 340 that the estimation system 170 predicts before an actual transition. The transition time 330 can give the operator sufficient time for a gradual takeover and manual inputs through factoring vehicle speed, operator preferences (e.g., full manual, level 1 automation, etc.). During the transition time 330, the vehicle 100 and the operator can share control such that the operator inputs primary commands and the vehicle 100 assists with secondary commands during the transition time. For example, primary commands are steering and speed while secondary commands are adapting headlights, brake assist (i.e., pre-charging brakes), etc. As such, the operator primarily controls the vehicle 100 during the transition time 330 unlike the automated region 320.

Additionally, the transition time 330 can factor a stopping distance currently for the vehicle 100 and response times involving the operator. The stopping distance is a factor in the event that a takeover is unsuccessful upon the transition time 330 expiring. The response time may be cognitive and attentiveness measures about the operator derived from the sensor data 250 associated with driver monitoring. The response time can also be predefined by the National Highway Traffic Safety Administration (NHTSA), SAE, etc. For instance, NHTSA sets ten seconds for scheduling a transfer of control from level 3 according to cognitive studies plus a buffer period. In one approach, the estimation system 170 computes the transition time 330 using the current speed, stopping distance, the position 340, etc. In this way, the transition time 330 is at least as long as a stopping distance plus additional time for safety.

Upon the takeover and manual control of the vehicle 100 by an operator during the transition time involving insufficient actions, the emulation module 220 and the output system 135 can generate additional alerts (e.g., visual, auditory, etc.). For example, the additional alerts escalate visually, audibly, tactilely, etc., until the sensor data 250 indicates sufficient awareness by the operator. If action after the additional alerts are still insufficient, the automated driving module(s) 160 automatically stops and pullovers the vehicle 100 when approaching the end of the transition time 330. Accordingly, the estimation system 170 improves transitioning the vehicle 100 from automatic control and a takeover using virtual markings while maintaining safety upon manual control by the operator being inadequate.

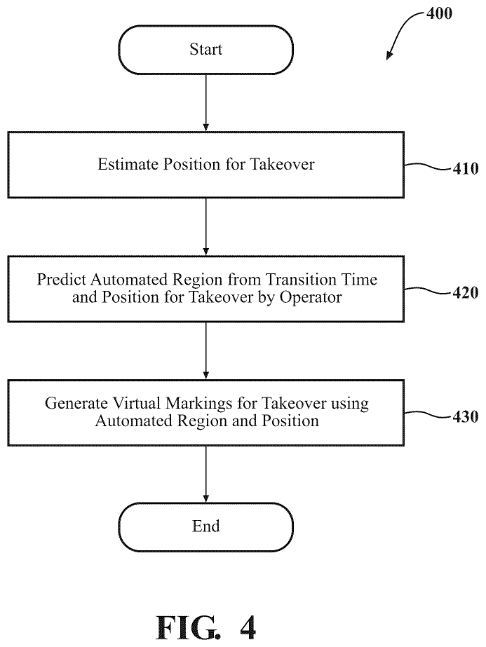

Turning now to FIG. 4, a flowchart of a method 400 that is associated with transferring automatic control of a vehicle using virtual markings and a buffer zone that are estimated is illustrated. Method 400 will be discussed from the perspective of the estimation system 170 of FIGS. 1 and 2. While the method 400 is discussed in combination with the estimation system 170, it should be appreciated that the method 400 is not limited to being implemented within the estimation system 170 but is instead one example of a system that may implement the method 400. Furthermore, the method 400 reduces unnecessary stress and urgent feelings from confidence with automatic control through improving a takeover and manual control with virtual markings. The method 400 also increases operator understanding about system capabilities, availability, and limits for automatic control that set the operational domain. In this way, the estimation system 170 also prevents hard disengagement and unavailability of automatic control by operators following rather than ignoring warnings.

At 410, the estimation system 170 estimates a position for a takeover. Here, the position can represent a geographic boundary for a planned takeover estimated with map data (e.g., road edges, road boundaries, etc.). For example, the geography changes from a high-speed area to a local area and the vehicle 100 is unable to execute automatic control for certain automation levels among the local area. As previously explained, the operator and the estimation system 170 can also negotiate a plan for transferring from the automatic control, such as through route planning and operator preferences (e.g., manual driving on high-speed areas). Furthermore, the estimation system 170 can schedule the takeover by comparing the position with map data indicating that the vehicle is incapable of autonomously controlling certain driving maneuvers beyond an automated region and the operator can manage manual control upon the takeover.

In one embodiment, the estimation system 170 triggers the takeover at the position due to driving conditions that conflict with an automation level. For example, the vehicle 100 is unable to operate under level 3 when a vehicle ahead is maneuvering aggressively using perceptions predicted with the sensor data 250. Similarly, the vehicle 100 is unable to operate under level 5 when a road is icy. In this way, the estimation system 170 accounts for scheduled and unscheduled takeovers of the vehicle 100 using map data, automation levels, driving conditions, etc., thereby improving system reliability and robustness.

At 420, the estimation system 170 predicts the automated region from a transition time and the position for the takeover by an operator. As previously explained, the transition time can be a buffer zone where the vehicle 100 gradually switches from automated driving to manual that demands feedback since capabilities become inadequate for automatic driving. The transition time can be predetermined according to an automation level and capabilities of the automation level for autonomously controlling the vehicle 100 within an area. For instance, a takeover from level 5 to levels 0-3 is requested by the estimation system 170 since the vehicle 100 cannot safely navigate an area without the operator primarily controlling the vehicle 100 with manual inputs.

At 430, the emulation module 220 generates virtual markings for the takeover using the automated region and the position. In one approach, the emulation module 220 displays the virtual markings within the automated region and the position with a virtual twin of the vehicle 100 and a vehicle ahead on a road. The virtual markings can emulate a caution zone, painted lines, slow zones, etc., on the road. As such, displaying the virtual markings can assist the operator with understanding operating domains and capabilities for an automation level and increases situational awareness. In another example, the virtual markings can be feedback generated on a HUD through overlaying images using augmented reality involving a scene surrounding the vehicle 100.

Moreover, in another approach, the emulation module 220 color-codes the virtual markings and the automated region to indicate automation levels, automation statuses, etc. This can assist the operator to become familiar with transferring between automatic control and a scenario demanding manual inputs. Furthermore, the automated region can be associated with a distance and time (e.g., several seconds) until a takeover at the position where the virtual markings provide insightful feedback for a smooth transition. Besides visual, the virtual markings can involve audible, haptic, etc., warnings about the takeover before the transition time. For example, the one or more actuators 150 can vibrate a vehicle element corresponding with points within the automated region. In one approach, the one or more actuators 150 are one of an electromagnetic suspension that is purpose built and a haptic motor. The vehicle element may be one of a seat base, a holster, a chassis, and a steering wheel. For instance, a haptic motor increasingly vibrates the steering wheel along the virtual markings when approaching the position, such as for mimicking the feel of rumble strips virtually. Accordingly, the estimation system 170 improves operator knowledge, cognition, and awareness about automation capabilities and reduces stress associated with a takeover, thereby improving vehicle safety and automation confidence.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., level 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include the output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the estimation system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140 and, thus, may be partially or fully autonomous as defined by the SAE levels 0 to 5.

The processor(s) 110, the estimation system 170, and/or the automated driving module(s) 160 can be operatively connected to communicate with the various vehicle systems 140 and/or individual components thereof. For example, returning to FIG. 1, the processor(s) 110, the estimation system 170, and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140.

The processor(s) 110, the estimation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the estimation system 170, and/or the automated driving module(s) 160 can control the direction and/or speed of the vehicle 100. The processor(s) 110, the estimation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the estimation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system comprising:
a memory storing instructions that, when executed by a processor, cause the processor to:
estimate a position for a takeover by a vehicle that is directly controlling driving maneuvers;
predict an automated region from a transition time and the position for the takeover by an operator; and
generate virtual markings for the takeover using the automated region and the position, wherein the virtual markings exist within the automated region and the position indicates an area for manual feedback to the vehicle.

2. The estimation system of claim 1 further including instructions to:
upon the takeover and manual control of the vehicle by the operator during the transition time being insufficient, stop the vehicle automatically by an automated driving module.

3. The estimation system of claim 1, wherein the instructions to generate the virtual markings further include instructions to:
display the virtual markings on a heads-up display (HUD) through overlaying images that augment a scene surrounding the vehicle, and the virtual markings emulate a caution zone on a road within the scene.

4. The estimation system of claim 3 further including instructions to:
schedule the takeover by comparing the position with map data indicating that the vehicle is incapable of autonomously controlling the driving maneuvers beyond the automated region and the operator is capable of the takeover; and
share control between the vehicle and the operator during the transition time, wherein the operator inputs primary commands and the vehicle assists with secondary commands during the transition time.

5. The estimation system of claim 3 further including instructions to:
vibrate by a component a vehicle element corresponding with points within the caution zone, wherein the component is one of an electromagnetic suspension and a haptic motor and the vehicle element is one of a seat base, a holster, a chassis, and a steering wheel.

6. The estimation system of claim 5, wherein:
the transition time is predetermined according to an automation level and capabilities of the automation level for autonomously controlling the vehicle within the area; and
the automated region is color-coded according to the automation level.

7. The estimation system of claim 1 further including instructions to:
plan the position according to a changing geography associated with the area, wherein the geography changes from a high-speed area to a local area.

8. The estimation system of claim 1, wherein the transition time factors attentiveness of the operator derived from sensor data, a stopping distance of the vehicle, and an automation level associated with the driving maneuvers.

9. The estimation system of claim 1, wherein the instructions to predict the automated region further include instructions to factor a speed of the vehicle towards the position.

10. A non-transitory computer-readable medium comprising:
instructions that when executed by a processor cause the processor to:
estimate a position for a takeover by a vehicle that is directly controlling driving maneuvers;
predict an automated region from a transition time and the position for the takeover by an operator; and
generate virtual markings for the takeover using the automated region and the position, wherein the virtual markings exist within the automated region and the position indicates an area for manual feedback to the vehicle.

11. The non-transitory computer-readable medium of claim 10 further including instructions to:
upon the takeover and manual control of the vehicle by the operator during the transition time being insufficient, stop the vehicle automatically by an automated driving module.

12. A method comprising:
estimating a position for a takeover by a vehicle that is directly controlling driving maneuvers;
predicting an automated region from a transition time and the position for the takeover by an operator; and
generating virtual markings for the takeover using the automated region and the position, wherein the virtual markings exist within the automated region and the position indicates an area for manual feedback to the vehicle.

13. The method of claim 12 further comprising:
upon the takeover and manual control of the vehicle by the operator during the transition time being insufficient, stopping the vehicle automatically by an automated driving module.

14. The method of claim 12, wherein generating the virtual markings further includes:
displaying the virtual markings on a heads-up display (HUD) through overlaying images that augment a scene surrounding the vehicle, and the virtual markings emulate a caution zone on a road within the scene.

15. The method of claim 14 further comprising:
scheduling the takeover by comparing the position with map data indicating that the vehicle is incapable of autonomously controlling the driving maneuvers beyond the automated region and the operator is capable of the takeover; and
sharing control between the vehicle and the operator during the transition time, wherein the operator inputs primary commands and the vehicle assists with secondary commands during the transition time.

16. The method of claim 14 further comprising:
vibrating by a component a vehicle element corresponding with points within the caution zone, wherein the component is one of an electromagnetic suspension and a haptic motor and the vehicle element is one of a seat base, a holster, a chassis, and a steering wheel.

17. The method of claim 16, wherein:
the transition time is predetermined according to an automation level and capabilities of the automation level for autonomously controlling the vehicle within the area; and
the automated region is color-coded according to the automation level.

18. The method of claim 12 further comprising:
planning the position according to a changing geography associated with the area, wherein the geography changes from a high-speed area to a local area.

19. The method of claim 12, wherein the transition time factors attentiveness of the operator derived from sensor data, a stopping distance of the vehicle, and an automation level associated with the driving maneuvers.

20. The method of claim 12, wherein predicting an automated region further includes factoring a speed of the vehicle towards the position.
